(19) United States
(12) Patent Application Publication
(10) Pub. No.: US 2024/0427147 A1
(43) Pub. Date: Dec. 26, 2024

(54) ILLUMINATION ASSEMBLY, DISPLAY LIGHT MACHINE, AND NEAR-EYE DISPLAY DEVICE

(71) Applicant: ZHEJIANG SUNNYVERSE TECHNOLOGY CO., LTD., Hangzhou (CN)

(72) Inventors: Qian ZHANG, Hangzhou (CN); Hang CHEN, Hangzhou (CN); Zengxin HU, Hangzhou (CN)

(21) Appl. No.: 18/518,957

(22) Filed: Nov. 25, 2023

(30) Foreign Application Priority Data
Jun. 21, 2023 (CN) 202310745611.8

(51) Int. Cl. G02B 27/01

(52) U.S. Cl. CPC G02B 27/0172

(57) ABSTRACT

An illumination assembly, a display light machine, and a near-eye display device are provided. The illumination assembly includes an illumination light source, a light-homogenizing color-mixing device, and a relay assembly. The illumination light source includes a substrate, a first light-emitting element, a second light-emitting element, and a third light-emitting element. The first light-emitting element, the second light-emitting element, and the third light-emitting element are arranged on the substrate. The light-homogenizing color-mixing device is arranged on a light exit side of the illumination light source and configured to shape and homogenize multi-color illumination light to form the mixed-color illumination light. The relay assembly is arranged on a light exit side of the light-homogenizing color-mixing device and configured to transmit the mixed-color illumination light from the light-homogenizing color-mixing device to the display chip to modulate the mixed-color illumination light into image light.

### CROSS-REFERENCE TO RELATED APPLICATIONS

This application claims priority to Chinese patent application No. 202310745611.8, filed on Jun. 21, 2023, and titled “ILLUMINATION ASSEMBLY, DISPLAY LIGHT MACHINE, AND NEAR-EYE DISPLAY DEVICE”. The content of the above identified application is hereby incorporated herein in their entireties by reference.

### TECHNICAL FIELD

The present disclosure relates to the field of near-eye display technologies, and in particular, to an illumination assembly, a display light machine, and a near-eye display device.

### BACKGROUND

In recent years, with the continuous development of new display technologies, the market related to wearable display devices (such as AR glasses) has become increasingly mature. Currently, among various schemes in a field of near-eye display, mainstream schemes include various forms such as BB, free-form-surface prisms, arrayed optical waveguides, and diffracted optical waveguides. An AR display module based on the waveguide scheme has been widely concerned and adopted due to advantages such as a small size, thinness, and good experience. Current mainstream waveguide display schemes include liquid crystal on silicon (LCoS), liquid crystal display (LCD), digital light processing (DLP), and the like. Since the above display chips are not self-illuminating, corresponding illumination systems are required to coordinate therewith. In a full-color display illumination scheme in the field of micro-display, in order to achieve better color performance and wider color gamut, a manner of using RGB (Red-Green-Blue) three-color light for color combination and coordination with a Color Sequential (CS) timing circuit is widely used.

For a traditional light machine, a light source, when being a multi-color illumination light source, is required to coordinate with a conventional color-combining device such as a traditional dichroic mirror to realize color combination of the RGB three-color light. Moreover, generally, in CS-based full-color display optical schemes, color combination of the RGB three-color light is realized by means of a dichroic mirror.

The dichroic mirror is featured with almost complete transmission of light with certain wavelengths and almost complete reflection of light with other wavelengths. The dichroic mirror can combine light from different directions in a desired direction by reflection or projection to achieve a color combination effect. However, whether it is limited by angle deviation in machining and assembly of the color-combining device or a difference in reflectivity or transmittance of the dichroic mirror corresponding to different wavelengths and different incident angles of incident light, especially in the case of a relatively large angle distribution range of incident light and a relatively wide spectral range thereof, a corresponding color combination effect may be significantly affected.

### SUMMARY

Based on the above technical problems, it is necessary to provide an illumination assembly, a display light machine, and a near-eye display device, which can realize homogenization and mixing of a multi-color illumination light source without relying on the conventional color-combining device such as the traditional dichroic mirror.

The present disclosure provides an illumination assembly, configured to provide mixed-color illumination light for a display chip, the illuminating assembly including:
an illumination light source including a substrate, a first light-emitting element, a second light-emitting element, and a third light-emitting element, wherein the first light-emitting element, the second light-emitting element, and the third light-emitting element are arranged on the substrate;
a light-homogenizing color-mixing device, wherein the light-homogenizing color-mixing device is arranged on a light exit side of the illumination light source and configured to shape and homogenize multi-color illumination light emitted by the first light-emitting element, the second light-emitting element, and the third light-emitting element to form the mixed-color illumination light; and
a relay assembly, wherein the relay assembly is arranged on a light exit side of the light-homogenizing color-mixing device and configured to transmit the mixed-color illumination light from the light-homogenizing color-mixing device to the display chip to modulate the mixed-color illumination light into image light.

In the illumination assembly in the present disclosure, when the first light-emitting element, the second light-emitting element, and the third light-emitting element are arranged on the substrate, the multi-color illumination light can be provided, and when the light-homogenizing color-mixing device is arranged on the light exit side of the illumination light source, the multi-color illumination light can be shaped and homogenized to form the mixed-color illumination light, which can ensure a good color mixing effect while omitting the traditional color-combining device. In this way, on the one hand, an overall space of the illumination assembly can be reduced, and the cost can be saved to some extent. On the other hand, color cast caused by assembly tolerances similar to a color combination scheme of the traditional dichroic mirror can be avoided.

In some embodiments, the light-homogenizing color-mixing device is a microlens array or a binary optical device. In an embodiment, a plurality of light-homogenizing color-mixing devices are provided, and the plurality of light-homogenizing color-mixing devices are stacked in a light path between the illumination light source and the relay assembly.

In this way, by providing the plurality of light-homogenizing color-mixing devices being stacked in the light path between the illumination light source and the relay assembly, it enables respective colors of the formed mixed-color illumination light to be distributed more uniformly.

In some embodiments, the illumination assembly includes three light-homogenizing color-mixing devices, wherein the three light-homogenizing color-mixing devices are stacked in a light path between the illumination light source and the relay assembly. Alternatively, the illumination assembly includes two light-homogenizing color-mixing devices, wherein the two light-homogenizing color-mixing devices are stacked in a light path between the illumination light source and the relay assembly.

In some embodiments, the illumination light source is one of an RGBW (Red-Green-Blue-White) four-in-one light source, an RGGB (Red-Green-Green-Blue) four-in-one light source, and an RGB three-in-one light source. In some embodiments, an angle distribution range of incident light received by the relay assembly is less than a range of maximum overlapping region of lights with different colors in the mixed-color illumination light.

In this way, within this range, the respective colors of the mixed-color illumination light are distributed more uniformly.

In some embodiments, an angle distribution range of incident light received by the light-homogenizing color-mixing device is greater than a maximum value of a range of angular distribution of the multi-color illumination light.

In this way, the range of angular distribution of the multi-color illumination light is within the angle distribution range of incident light received by the light-homogenizing color-mixing device, which can prevent large-area smearing phenomena.

In some embodiments, the relay assembly includes a beam splitter (BS) prism, a first relay lens, and a collimating lens. The BS prism is arranged in a light path between the first relay lens and the light-homogenizing color-mixing device. In some embodiments, the collimating lens is arranged in a light path between the illumination light source and the light-homogenizing color-mixing device.

In this way, the BS prism is arranged in the light path between the first relay lens and the light-homogenizing color-mixing device and configured to transmit the mixed-color illumination light to the display chip to modulate the mixed-color illumination light into image light.

In some embodiments, the relay assembly includes a polarizer, a polarizing beam splitter (PBS) prism, a first relay lens, a quarter-wave plate, and a curved mirror. The polarizer is arranged in a light path between the illumination light source and the PBS prism. The first relay lens and the curved mirror are respectively arranged on two opposite sides of the PBS prism. The quarter-wave plate is arranged in a light path between the PBS prism and the curved mirror.

In this way, the polarizer is arranged in the light path between the illumination light source and the PBS prism and configured to convert the mixed-color illumination light into S-polarized light. The S-polarized light is transmitted to the display chip through the PBS prism. The display chip modulates and converts the S-polarized light into P-polarized light, transmits the P-polarized light to the quarter-wave plate via the PBS prism, and then transmits the P-polarized light to the curved mirror through the quarter-wave plate. Then, the curved mirror transmits the P-polarized light to the quarter-wave plate. The quarter-wave plate converts the P-polarized light into S-polarized light which is finally transmitted to the imaging lens via the PBS prism.

In some embodiments, the relay assembly includes a turning prism, a second relay lens, and a collimating lens. The turning prism is arranged in a light path between the illumination light source and the polarizer. The second relay lens is arranged in a light path between the turning prism and the polarizer. The collimating lens is arranged in a light path between the illumination light source and the light-homogenizing color-mixing device.

In this way, the turning prism can coordinate with the second relay lens to transmit the mixed-color illumination light from the light-homogenizing color-mixing device to the PBS prism.

In some embodiments, the illumination assembly includes a collimating lens arranged in a light path between the illumination light source and the light-homogenizing color-mixing device.

According to another aspect of the present disclosure, the present disclosure further provides a display light machine, including:
the above illumination assembly;
an imaging lens; and
a display chip, wherein the display chip is arranged in a light path between the illumination assembly and the imaging lens and configured to modulate the mixed-color illumination light from the illumination assembly into image light which is modulated for imaging via the imaging lens.

In this way, the display chip can modulate the mixed-color illumination light from the illumination assembly into image light which is modulated for imaging via the imaging lens, bringing an excellent imaging effect.

In some embodiments, the illumination assembly further includes a plurality of light-homogenizing color-mixing devices, wherein the plurality of light-homogenizing color-mixing devices are stacked in a light path between the illumination light source and the relay assembly.

In some embodiments, an angle distribution range of incident light received by the relay assembly is less than a range of maximum overlapping region of lights with different colors in the mixed-color illumination light.

In some embodiments, an angel distribution range of incident light received by the light-homogenizing color-mixing device is greater than a maximum value of a range of angular distribution of the multi-color illumination light.

According to another aspect of the present disclosure, the present disclosure further provides a near-eye display device, including:
a device body; and
the above display light machine, wherein the display light machine is mounted on the device body.

In some embodiments, the illumination assembly further includes a plurality of light-homogenizing color-mixing devices, wherein the plurality of light-homogenizing color-mixing devices are stacked in a light path between the illumination light source and the relay assembly.

In some embodiments, an angle distribution range of incident light received by the relay assembly is less than a range of maximum overlapping region of lights with different colors in the mixed-color illumination light.

In some embodiments, an angel distribution range of incident light received by the light-homogenizing color-mixing device is greater than a maximum value of a range of angular distribution of the multi-color illumination light.

### BRIEF DESCRIPTION OF THE DRAWINGS

FIG. 1 is a schematic structural diagram of a display light machine according to a first embodiment of the present disclosure.

FIG. 2 is a schematic structural diagram of the display light machine in a second embodiment.

FIG. 3 is a schematic diagram of distribution of light-emitting elements with respective colors in an illumination light source according to a first embodiment of the present disclosure.

FIG. 4 is a schematic diagram of distribution of light-emitting elements with respective colors in an illumination light source according to a second embodiment of the present disclosure.

FIG. 5 is a schematic diagram of distribution of light-emitting elements with respective colors in an illumination light source according to a third embodiment of the present disclosure.

FIG. 6 is a diagram of angle distribution of a first light-emitting element at a viewing surface A of a light-homogenizing color-mixing device corresponding to FIG. 5.

FIG. 7 is a diagram of angle distribution of a second light-emitting element at a viewing surface A of the light-homogenizing color-mixing device corresponding to FIG. 5.

FIG. 8 is a diagram of angle distribution of a third light-emitting element at a viewing surface A of the light-homogenizing color-mixing device corresponding to FIG. 5.

FIG. 9 is a diagram of angle distribution of a first light-emitting element at a viewing surface B of the light-homogenizing color-mixing device corresponding to FIG. 5.

FIG. 10 is a diagram of angle distribution of a second light-emitting element at a viewing surface B of the light-homogenizing color-mixing device corresponding to FIG. 5.

FIG. 11 is a diagram of angle distribution of a third light-emitting element at a viewing surface B of the light-homogenizing color-mixing device corresponding to FIG. 5.

FIG. 12 is a diagram of partial angle distribution of the first light-emitting element in FIG. 9.

FIG. 13 is a diagram of partial angle distribution of the second light-emitting element in FIG. 10.

FIG. 14 is a diagram of partial angle distribution of the third light-emitting element in FIG. 11.

FIG. 15 is a diagram of angle distribution of a first light-emitting element at a viewing surface C of the light-homogenizing color-mixing device corresponding to FIG. 5;

FIG. 16 is a diagram of angle distribution of a second light-emitting element at a viewing surface C of the light-homogenizing color-mixing device corresponding to FIG. 5;

FIG. 17 is a diagram of angle distribution of a third light-emitting element at a viewing surface C of the light-homogenizing color-mixing device corresponding to FIG. 5.

FIG. 18 is a diagram of uniform distribution of light sources with respective colors corresponding to FIG. 5 in an overlapping region.

FIG. 19 is a diagram of comparisons between the light sources in respective colors in FIG. 18 in an overlapping region.

### MAIN REFERENCE SIGNS

10 represents an illumination light source; 11 represents a substrate; 12 represents a first light-emitting element; 13 represents a second light-emitting element; 14 represents a third light-emitting element; 15 represents a fourth light-emitting element; 20 represents a light-homogenizing color-mixing device; 30 represents a relay assembly; 31 represents a BS prism; 32 represents a first relay lens; 33 represents a polarizer; 34 represents a PBS prism; 35 represents a quarter-wave plate; 36 represents a curved mirror; 37 represents a turning prism; 38 represents a second relay lens; 40 represents a collimating lens; 50 represents a display chip; 60 represents an imaging lens; and 61 represents an exit pupil plane.

The present disclosure is described in further detail according to the above main reference signs in conjunction with the accompanying drawings and specific implementations.

### DETAILED DESCRIPTION OF THE EMBODIMENT

In order to make the above objectives, features and advantages of the present disclosure more obvious and understandable, specific implementations of the present disclosure are described in detail below with reference to the accompanying drawings. In the following description, many specific details are set forth in order to fully understand the present disclosure. However, the present disclosure can be implemented in many other ways different from those described herein, and those skilled in the art can make similar improvements without departing from the connotation of the present disclosure. Therefore, the present disclosure is not limited by specific embodiments disclosed below.

In the description of the present disclosure, it should be understood that the orientation or position relationships indicated by the terms “central”, “longitudinal”, “transverse”, “length”, “width”, “thickness”, “up”, “down”, “front”, “back”, “left”, “right”, “vertical”, “horizontal”, “top”, “bottom”, “inner”, “outer”, “clockwise”, “counterclockwise”, “axial”, “radial”, “circumferential”, etc. are based on the orientation or position relationships shown in the accompanying drawings and are intended to facilitate the description of the present disclosure and simplify the description only, rather than indicating or implying that the apparatus or element referred to must have a particular orientation or be constructed and operated in a particular orientation, and therefore are not to be interpreted as limiting the present disclosure.

In addition, the terms “first” and “second” are used for descriptive purposes only, which cannot be construed as indicating or implying a relative importance or implicitly specifying the number of the indicated technical features. Thus, the features defined with “first” and “second” may explicitly or implicitly include at least one feature. In the description of the present disclosure, “a plurality of” means at least two, such as two or three, unless specifically stated otherwise.

In the present disclosure, unless otherwise specifically stated and limited, the terms “install”, “join”, “connect”, “fix”, etc. should be understood in a broad sense, such as, a fixed connection, a detachable connection, or an integral connection; a mechanical connection, or an electrical connection; a direct connection, an indirect connection through an intermediate medium, internal communication between two elements, or an interaction of two elements, unless otherwise expressly defined. For those of ordinary skill in the art, the specific meanings of the foregoing terms in the present invention can be understood on a case-by-case basis.

In the present disclosure, unless otherwise explicitly specified and defined, a first feature being “on” or “under” a second feature may be a case that the first feature is in direct contact with the second feature, or the first feature is in indirect contact with the second feature via an intermediate medium. Furthermore, the first feature being “over”, “above” and “on top of” the second feature may be a case that the first feature is directly above or obliquely above the second feature, or only means that the level of the first feature is higher than that of the second feature. The first feature being “below”, “underneath” or “under” the second feature may be a case that the first feature is directly underneath or obliquely underneath the second feature, or only means that the level of the first feature is lower than that of the second feature.

It should be noted that when one element is referred to as “fixed to” or “arranged on” another element, it may be directly disposed on the another element or an intermediate element may exist. When one element is considered to be “connected to” another element, it may be directly connected to the another element or an intermediate element may co-exist. The terms “vertical”, “horizontal”, “up”, “down”, “left”, “right” and similar expressions used herein are for illustrative purposes only, and do not represent unique embodiments.

For a traditional light machine, a light source, when being a multi-color illumination light source 10, is required to coordinate with a conventional color-combining device such as the traditional dichroic mirror to realize color combination of RGB three-color light. However, whether it is limited by angle deviation in machining and assembly of the color-combining device or a difference in reflectivity or transmittance of a dichroic mirror corresponding to different wavelengths and different light angles, a color combination effect may be significantly affected.

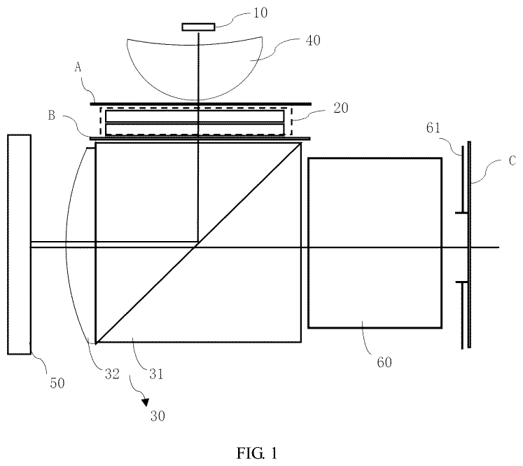

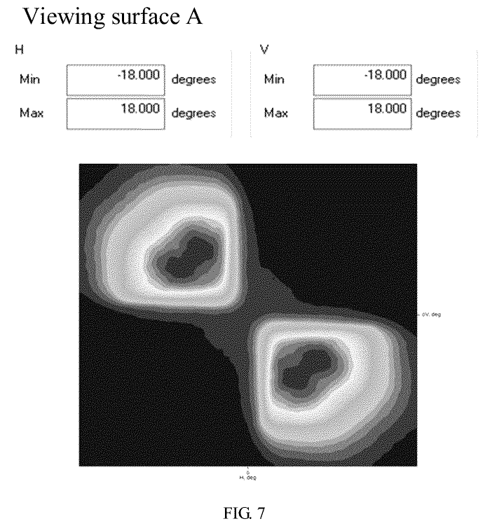

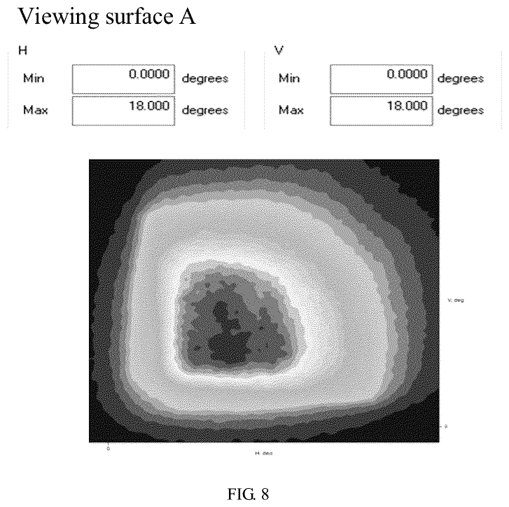

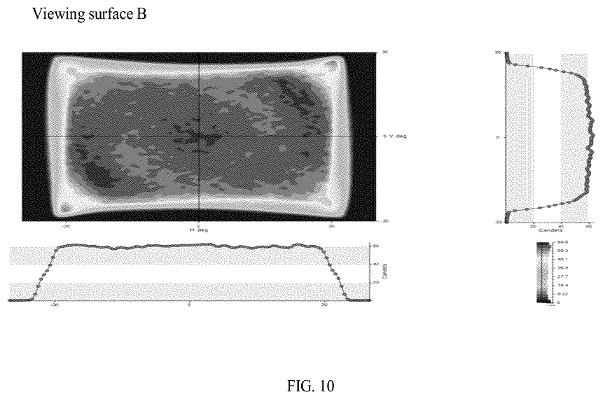

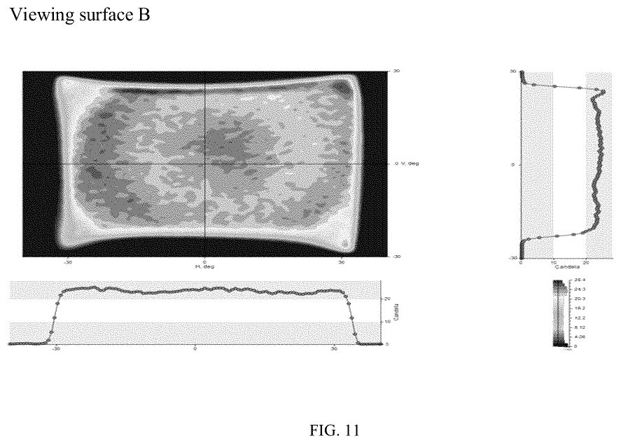

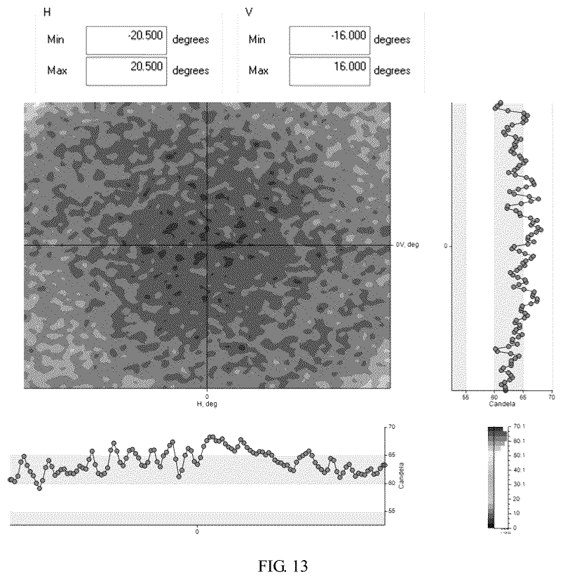

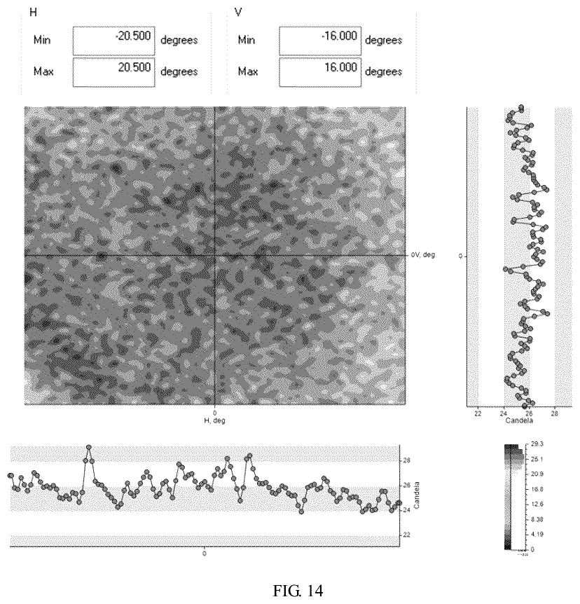

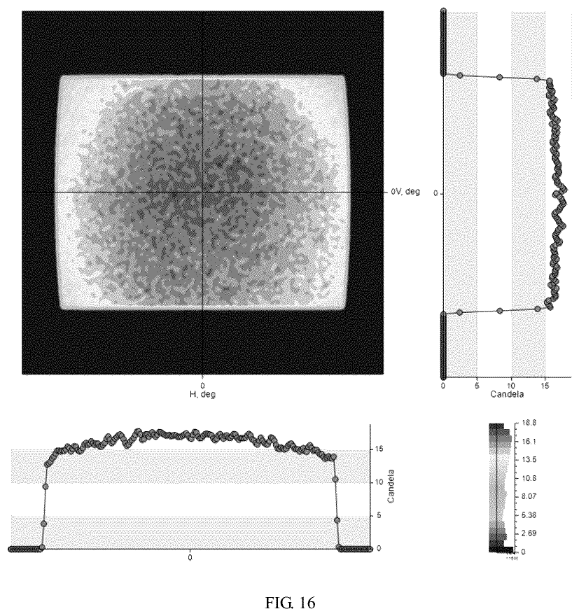

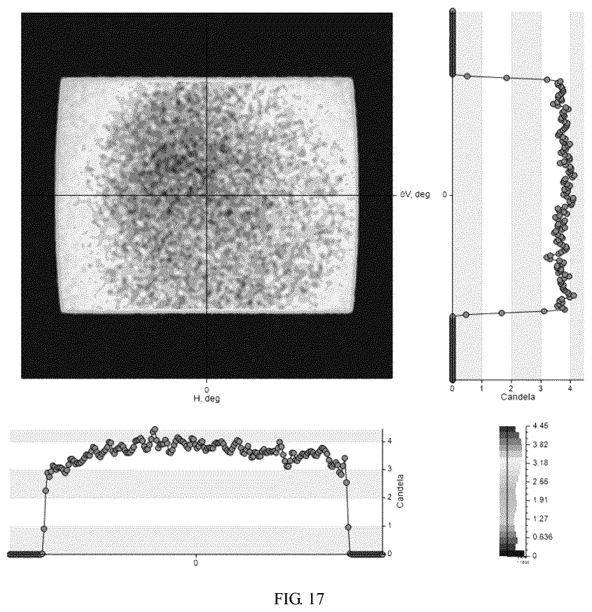

Referring to FIG. 1 to FIG. 19, based on the above technical problems, the present disclosure provides an illumination assembly, a display light machine, and a near-eye display device, which can realize homogenization and mixing of the multi-color illumination light source 10 without relying on the conventional color-combining device such as the traditional dichroic mirror.

Specifically, referring to FIG. 1 and FIG. 2, this embodiment provides a display light machine. The display light machine includes an illumination assembly, an imaging lens 60, and a display chip 50. The display chip 50 is arranged in a light path between the illumination assembly and the imaging lens 60 and configured to modulate the mixed-color illumination light from the illumination assembly into image light which is modulated for imaging via the imaging lens 60. It is to be noted that the imaging lens 60 has an exit pupil plane 61.

In this way, the display chip 50 can modulate the mixed-color illumination light from the illumination assembly into image light which is modulated for imaging via the imaging lens 60, bringing an excellent imaging effect. Therefore, the conventional color-combining device is omitted, space is reduced, and the cost is more advantageous. In this way, the display light machine is more compact in structure, and is lightweight and compact.

Currently, among various schemes in the field of near-eye display, mainstream schemes include various forms such as BB (Birdbath), free-form-surface prisms, arrayed optical waveguides, and diffracted optical waveguides. An AR display module based on the waveguide scheme has been widely concerned and adopted due to advantages such as a small size, thinness, and good experience. Currently, among waveguide-based display schemes, mainstream schemes include LCOS, LCD, DLP, and the like. None of the above display chips 50 is self-illuminating. Therefore, a corresponding illumination system is required to coordinate therewith.

Specifically referring to FIG. 1, implementations of the present disclosure provide an illumination assembly configured to provide a mixed-color illumination light for a display chip 50. The illumination assembly includes an illumination light source 10, a light-homogenizing color-mixing device 20, and a relay assembly 30. The illumination light source 10 includes a substrate 11, a first light-emitting element 12, a second light-emitting element 13, and a third light-emitting element 14. The first light-emitting element 12, the second light-emitting element 13, and the third light-emitting element 14 are arranged on the substrate 11. The light-homogenizing color-mixing device 20 is arranged on a light exit side of the illumination light source 10 and configured to shape and homogenize multi-color illumination light emitted by the first light-emitting element 12, the second light-emitting element 13, and the third light-emitting element 14 to form the mixed-color illumination light. The relay assembly 30 is arranged on a light exit side of the light-homogenizing color-mixing device 20 and configured to transmit the mixed-color illumination light from the light-homogenizing color-mixing device 20 to the display chip 50 to modulate the mixed-color illumination light into an image light. In this embodiment, the first light-emitting element 12, the second light-emitting element 13, and the third light-emitting element 14 can emit light in three different colors respectively. Specifically, the first light-emitting element 12 can emit red light represented by R, the second light-emitting element 13 can emit green light represented by G, and the third light-emitting element 14 can emit blue light represented by B.

In the illumination assembly provided in the implementations of the present disclosure, when the first light-emitting element 12, the second light-emitting element 13, and the third light-emitting element 14 are arranged on the substrate 11 and configured to provide the multi-color illumination light. The light-homogenizing color-mixing device 20 is arranged on the light exit side of the illumination light source 10. The multi-color illumination light can be shaped and homogenized to form the mixed-color illumination light, which can ensure a good color mixing effect while omitting the traditional color-combining device. “Shaping” means that a propagation direction of the multi-color illumination light can be changed by the light-homogenizing color-mixing device 20. In this way, on the one hand, an overall space can be reduced, and the cost can be saved to some extent. On the other hand, color cast caused by assembly tolerances similar to the color combination scheme of the traditional dichroic mirror can be avoided.

It is to be noted that, for a traditional display light machine, a light source, when being a multi-color illumination light source 10, is required to collocate with the conventional color-combining device such as the traditional dichroic mirror to realize color combination of RGB three-color light. However, whether it is limited by angle deviation in machining and assembly of the color-combining device or a difference in reflectivity or transmittance of the dichroic mirror corresponding to different wavelengths and different light angles, a color combination effect may be significantly affected.

It is to be noted that the dichroic mirror is featured with almost complete transmission of light with certain wavelengths and almost complete reflection of light with other wavelengths. The dichroic mirror combines light from different directions in a desired direction by reflection or projection to achieve a color combination effect. In this embodiment, the light-homogenizing color-mixing device 20 realizes color combination on the basis of color uniformity. Specifically, the first light-emitting element 12, the second light-emitting element 13, and the third light-emitting element 14 are arranged on the substrate 11 and can provide multi-color illumination light on a same reference plane. Furthermore, the light-homogenizing color-mixing device 20 is arranged on the light exit side of the illumination light source 10, the multi-color illumination light can be shaped and homogenized to form the mixed-color illumination light, which can ensure a good color mixing effect while omitting the traditional color-combining device.

Specifically, the illumination assembly includes a collimating lens 40 arranged in a light path between the illumination light source 10 and the light-homogenizing color-mixing device 20. In this embodiment, the collimating lens 40 can be, but not limited to, a monolithic aspherical lens or a TIR collimating lens. The collimating lens 40 is made of an anti-UV yellowing material, and has a compact structure and a controllable cost.

Furthermore, the relay assembly 30 combines an illumination light path and an imaging light path to further reduce a size and a volume of the display light machine.

In some embodiments, the light-homogenizing color-mixing device 20 is a microlens array or a binary optical device. The light-homogenizing color-mixing device 20 is not limited to the microlens array, the binary optical device, or other micro-optical devices, as long as light angle distribution can be shaped and homogenized. In addition, machining or implementation of the light-homogenizing color-mixing device 20 is not limited to machining process forms such as wafer-level glass (WLG, printed on glass by using special glue to make an aspherical surface before wafer dicing), wafer-level optics (WLO), and nanoimprinting lithography (NIL).

In other embodiments, a plurality of light-homogenizing color-mixing devices 20 are provided, and the plurality of light-homogenizing color-mixing devices 20 are stacked in a light path between the illumination light source 10 and the relay assembly 30. In this way, by providing the plurality of light-homogenizing color-mixing devices 20 being stacked in the light path between the illumination light source 10 and the relay assembly 30, it can enable respective colors of the formed mixed-color illumination light to be distributed more uniformly.

It is to be noted that, since a plurality of light-homogenizing color-mixing devices 20 are provided, the light-homogenizing color-mixing device 20 located on an upper layer can shape and homogenize the multi-color illumination light from the first light-emitting element 12, the second light-emitting element 13, and the third light-emitting element 14 for the first time, and the light-homogenizing color-mixing device 20 located on a lower layer can further shape and homogenize the multi-color illumination light that has been shaped and homogenized once, thereby forming the mixed-color illumination light.

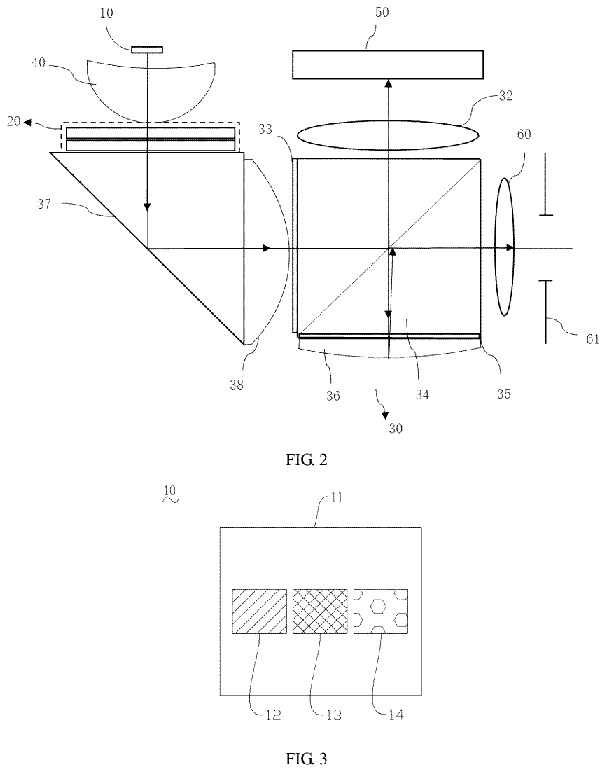

Referring to FIG. 3 to FIG. 5, in some embodiments, the illumination light source 10 is one of an RGBW four-in-one light source, an RGGB four-in-one light source, and an RGB three-in-one light source. In the above embodiments, R represents red, G represents green, B represents blue, and W represents white.

FIG. 3 shows an RGB three-in-one light source including the first light-emitting element 12, the second light-emitting element 13, and the third light-emitting element 14, which can emit red light, green light and blue light respectively.

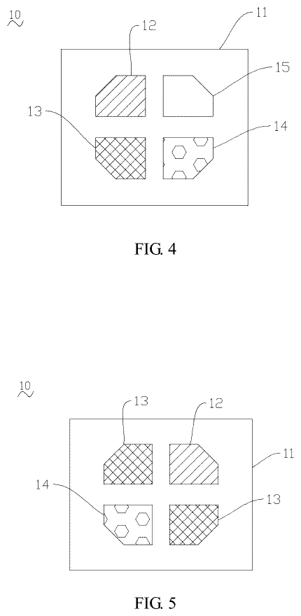

In some embodiments, the illumination light source 10 further includes a fourth light-emitting element 15 arranged on the substrate 11. The fourth light-emitting element 15 can emit white light. FIG. 4 shows an RGBW four-in-one light source including the first light-emitting element 12, the second light-emitting element 13, the third light-emitting element 14, and the fourth light-emitting element 15.

Referring to FIG. 5, in this embodiment, an LED light source based on RGGB arrangement is selected to expand relevant introduction to the solution in conjunction with a rectangular LCoS display chip 50 with an aspect ratio of 4:3, in which the number of the first light-emitting element 12 is one, the number of the second light-emitting element 13 is two, and the number of the third light-emitting element 14 is one. Specific embodiments will be described below based on the LED light source based on RGGB arrangement.

It may be understood that the shaping of angle distribution of illumination light in respective colors by the light-homogenizing color-mixing device 20 is required to meet a condition that a shape of angle distribution after shaping matches a shape and a proportion of the display chip 50, so as to prevent a waste in angle transmission to the greatest extent, so that overlapping of the angle distribution of the three-color light can be maximized as much as possible. Besides, the larger an angle overlapping region is, the better the light efficiency of the system is, so as to improve light efficiency of the system.

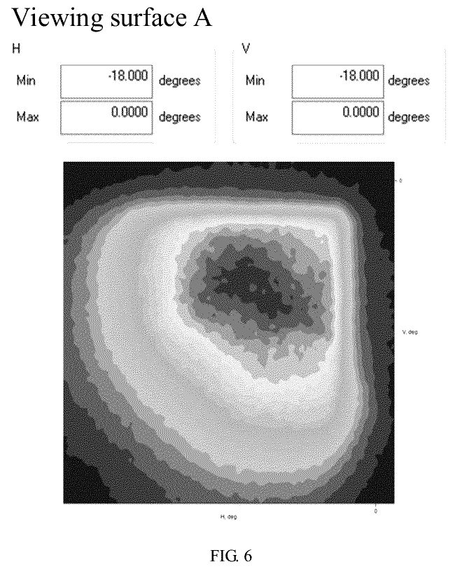

FIG. 6 to FIG. 8 comprehensively show angle distribution of emitting lights of R, G1, G2, and B after passing through the collimating lens 40 (that is, angle distribution of R, G1, G2, and B on a viewing surface A). Specific corresponding angle distribution of the RGB three-color light depends on their respective spatial position relationships. Limited by differences in positions of light-emitting surfaces of the R, G, and B, that is, the three-color light is separated in spatial position, and the angle distribution of the light in respective colors is also separated. As can be seen from the figures, an angle distribution range of R light is −18° to 0°, an angle distribution range of G1 light is −18° to 0°, an angle distribution range of G2 light is 0° to 18°, and an angle distribution range of B light is 0° to 18°.

LED positions are distributed differently, and the RGB three-color light is irradiated obliquely on the light-homogenizing color-mixing device 20, therefore, the RGB light with different position information may deform to some extent after angle shaping, but control is required to minimize an amount of deformation. Then, the light-homogenizing color-mixing device 20 is required accordingly. The light-homogenizing color-mixing device 20 is configured to shape and homogenize multi-color illumination light emitted through the collimating lens 40 to form the mixed-color illumination light. Moreover, a shape of angle distribution corresponding to the light-homogenizing color-mixing device 20 should match with a shape of the display chip 50, and the angle distribution should be as uniform as possible.

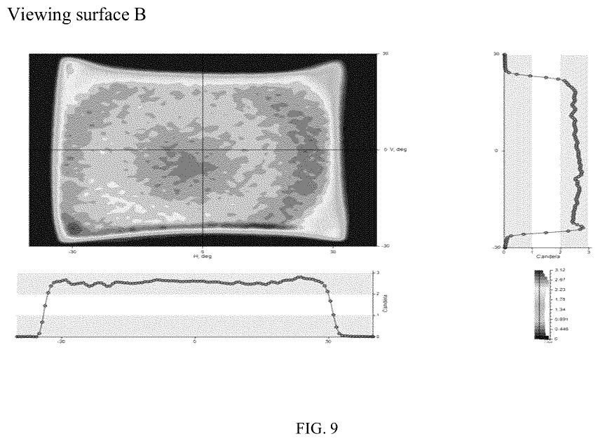

FIG. 9 to FIG. 11 comprehensively show angle distribution of emitting lights of R, G1, G2, and B after passing through the light-homogenizing color-mixing device 20 (that is, angle distribution of R, G1, G2, and B on a viewing surface B).

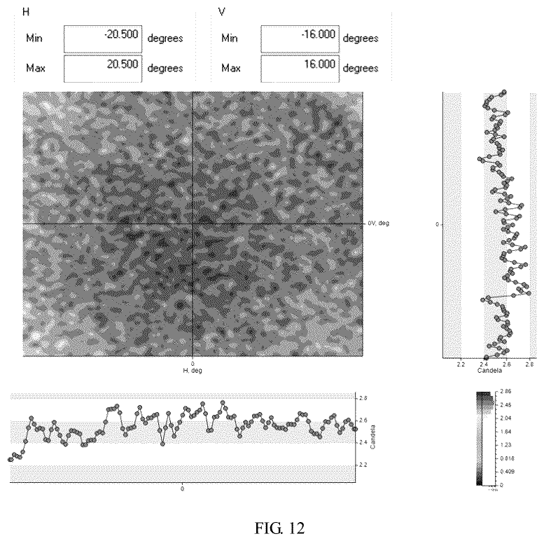

FIG. 12 to FIG. 14 are diagrams of partial angle distribution of light sources in respective colors. Specifically, FIG. 12 to FIG. 14 comprehensively show overlapping of angle distribution of three-color light and angle distribution of an overlapping region θ within a range (H: −20.5° to 20.5°; V: −16° to 16°), wherein H denotes a horizontal viewing angle, and V denotes a vertical viewing angle.

Referring to FIG. 12 to FIG. 14, angle distribution of light sources in respective colors within the range of the overlapping region θ is relatively uniform. Therefore, an angel distribution range α of incident light received by the relay assembly 30 is less than a range θ of maximum overlapping region of light in different colors in the mixed-color illumination light, that is, α≤θ. In this way, within this range, angle distribution of the respective colors of the mixed-color illumination light is more uniform.

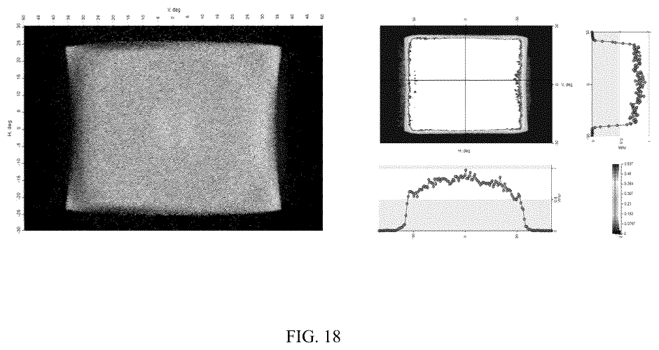

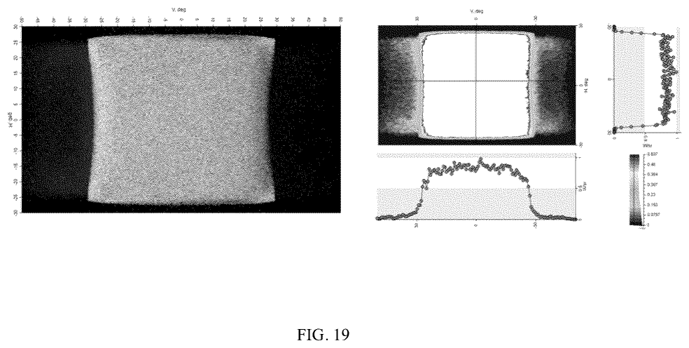

Furthermore, referring to FIG. 18 and FIG. 19, an angle distribution range β of incident light received by the light-homogenizing color-mixing device 20 is greater than a maximum value ψ(r,g,b)ₘₐₓ of a range of angular distribution of light in respective colors in the multi-color illumination light. In this way, the range of angle distribution of each color in the multi-color illumination light can be within the angle distribution range of corresponding to the light-homogenizing color-mixing device 20, which can prevent large-area smearing.

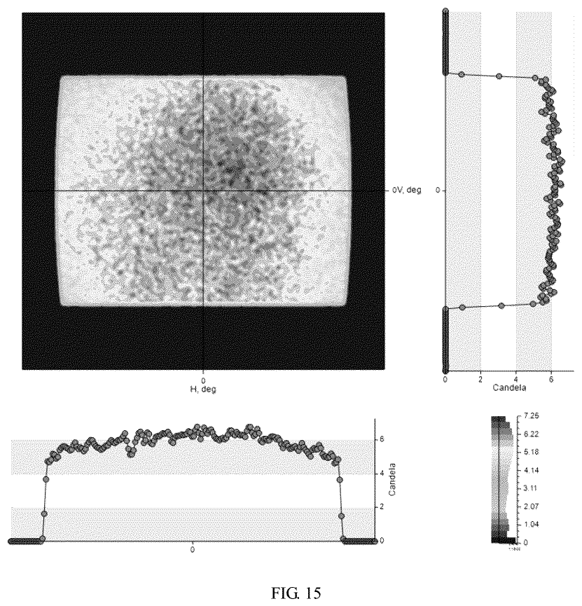

FIG. 15 to FIG. 17 show angle distribution of R, G1, G2, and B on a viewing surface C where the imaging lens 60 is located. From FIG. 15 to FIG. 17, relatively uniform angle distribution and a white field display effect with good color uniformity can be finally achieved on the exit pupil plane 61 of the target imaging lens 60.

Referring to FIG. 1, in some embodiments, the relay assembly 30 includes a BS prism 31 and a first relay lens 32. The BS prism 31 is arranged in a light path between the first relay lens 32 and the light-homogenizing color-mixing device 20. A monolithic aspherical lens is used as the first relay lens 32. The first relay lens 32 is, but not limited to, a traditional lens, which may alternatively be a binary optical device such as a Fresnel lens, as long as the volume of the display light machine is reduced as much as possible while a light transmission function is satisfied.

In this way, the BS prism 31 is arranged in the light path between the first relay lens 32 and the light-homogenizing color-mixing device 20 to transmit the mixed-color illumination light to the display chip 50 to modulate the mixed-color illumination light into image light.

Based on the above embodiments, the multi-color illumination light emitted by the first light-emitting element, the second light-emitting element, and the third light-emitting element in the illumination light source 10 can be transmitted to the light-homogenizing color-mixing device 20, and the light-homogenizing color-mixing device 20 can shape and homogenize the multi-color illumination light emitted through the first light-emitting element 12, the second light-emitting element 13, and the third light-emitting element 14 to form the mixed-color illumination light, which can ensure a good color mixing effect while omitting the traditional color-combining device. Furthermore, the mixed-color illumination light is transmitted to the display chip 50 via the BS prism 31 and the first relay lens 32, and the display chip 50 modulates the mixed-color illumination light into image light which is then transmitted to the imaging lens 60 through the BS prism 31 and the first relay lens 32 to be modulated for imaging.

Referring to FIG. 1, the relay assembly 30 includes a polarizer 33, a PBS prism 34, a first relay lens 32, a quarter-wave plate 35, and a curved mirror 36. The polarizer 33 is arranged in a light path between the illumination light source 10 and the PBS prism 34. The first relay lens 32 and the curved mirror 36 are respectively arranged on two opposite sides of the PBS prism 34. The quarter-wave plate 35 is arranged in a light path between the PBS prism 34 and the curved mirror 36.

In this way, the polarizer 33 is arranged in the light path between the illumination light source 10 and the PBS prism 34 to convert the mixed-color illumination light into S-polarized light. The S-polarized light is transmitted to the display chip 50 through the PBS prism 34. The display chip 50 modulates and converts the S-polarized light into P-polarized light, transmits the P-polarized light to the quarter-wave plate 35 via the PBS prism 34, and then transmits the P-polarized light to the curved mirror 36 through the quarter-wave plate 35. Then, the curved mirror 36 transmits the P-polarized light to the quarter-wave plate 35. In this case, the quarter-wave plate converts the P-polarized light into S-polarized light which is finally transmitted to the imaging lens 60 via the PBS prism 34 and is imaged through the exit pupil plane 61 of the imaging lens 60.

In this embodiment, the curved mirror 36 can be, but not limited to, a concave mirror.

For example, the relay assembly 30 includes a turning prism 37 and a second relay lens 38. The turning prism 37 is arranged in a light path between the illumination light source 10 and the polarizer 33. The second relay lens 38 is arranged in a light path between the turning prism 37 and the polarizer 33.

In this way, the turning prism 37 can cooperate with the second relay lens 38 to transmit the mixed-color illumination light from the light-homogenizing color-mixing device 20 to the PBS prism 34.

Based on the above embodiments, it is to be noted that the multi-color illumination light emitted by the first light-emitting element, the second light-emitting element, and the third light-emitting element in the illumination light source 10 can be transmitted to the light-homogenizing color-mixing device 20, and the light-homogenizing color-mixing device 20 can shape and homogenize the multi-color illumination light emitted through the first light-emitting element 12, the second light-emitting element 13, and the third light-emitting element 14 to form the mixed-color illumination light. Furthermore, the mixed-color illumination light is transmitted to the second relay lens 38 via the turning prism 37. Then, the polarizer 33 is arranged in a light path between the illumination light source 10 and the PBS prism 34 and configured to convert the mixed-color illumination light into S-polarized light.

The present disclosure also provides a near-eye display device, including a device body and a display light machine. The display light machine is mounted on the device body. It may be understood that in some embodiments, the device body may be a head-mounted device, that is, a glasses body or a helmet body.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the patent scope of the present disclosure. It should be noted that those of ordinary skill in the art may further make variations and improvements without departing from the conception of the present disclosure, and these all fall within the protection scope of the present disclosure. Therefore, the patent protection scope of the present disclosure should be subject to the appended claims.

What is claimed is:

1. An illumination assembly, configured to provide a mixed-color illumination light for a display chip, the illuminating assembly comprising:
an illumination light source comprising a substrate, a first light-emitting element, a second light-emitting element, and a third light-emitting element, wherein the first light-emitting element, the second light-emitting element, and the third light-emitting element are arranged on the substrate;
a light-homogenizing color-mixing device, wherein the light-homogenizing color-mixing device is arranged on a light exit side of the illumination light source and configured to shape and homogenize multi-color illumination lights emitted by the first light-emitting element, the second light-emitting element, and the third light-emitting element to form the mixed-color illumination light; and
a relay assembly, wherein the relay assembly is arranged on a light exit side of the light-homogenizing color-mixing device and configured to transmit the mixed-color illumination light from the light-homogenizing color-mixing device to the display chip to modulate the mixed-color illumination light into image light.

2. The illumination assembly of claim 1, wherein the light-homogenizing color-mixing device is a microlens array or a binary optical device.

3. The illumination assembly of claim 1, further comprising a plurality of light-homogenizing color-mixing devices, wherein the plurality of light-homogenizing color-mixing devices are stacked in a light path between the illumination light source and the relay assembly.

4. The illumination assembly of claim 3, further comprising three light-homogenizing color-mixing devices, wherein the three light-homogenizing color-mixing devices are stacked in a light path between the illumination light source and the relay assembly.

5. The illumination assembly of claim 3, further comprising two light-homogenizing color-mixing devices, wherein the two light-homogenizing color-mixing devices are stacked in a light path between the illumination light source and the relay assembly.

6. The illumination assembly of claim 1, wherein the illumination light source is one of an RGBW four-in-one light source, an RGGB four-in-one light source, and an RGB three-in-one light source.

7. The illumination assembly of claim 1, wherein an angle distribution range of incident light received by the relay assembly is less than a range of maximum overlapping region of lights with different colors in the mixed-color illumination light.

8. The illumination assembly of claim 1, wherein an angel distribution range of incident light received by the light-homogenizing color-mixing device is greater than a maximum value of a range of angular distribution of the multi-color illumination light.

9. The illumination assembly of claim 1, wherein the relay assembly comprises a beam splitter (BS) prism, a first relay lens, and a collimating lens, wherein the BS prism is arranged in a light path between the first relay lens and the light-homogenizing color-mixing device.

10. The illumination assembly of claim 9, wherein the collimating lens is arranged in a light path between the illumination light source and the light-homogenizing color-mixing device.

11. The illumination assembly of claim 1, wherein the relay assembly comprises a polarizer, a polarizing beam splitter (PBS) prism, a first relay lens, a quarter-wave plate, and a curved mirror, wherein the polarizer is arranged in a light path between the illumination light source and the PBS prism, the first relay lens and the curved mirror are respectively arranged on two opposite sides of the PBS prism, and the quarter-wave plate is arranged in a light path between the PBS prism and the curved mirror.

12. The illumination assembly of claim 11, wherein the relay assembly comprises a turning prism, a second relay lens and a collimating lens, wherein the turning prism is arranged in a light path between the illumination light source and the polarizer, the second relay lens is arranged in a light path between the turning prism and the polarizer, and the collimating lens is arranged in a light path between the illumination light source and the light-homogenizing color-mixing device.

13. A display light machine, comprising:
the illumination assembly of claim 1;
an imaging lens and
a display chip, wherein the display chip is arranged in a light path between the illumination assembly and the imaging lens and configured to modulate the mixed-color illumination light from the illumination assembly into image light which is modulated for imaging via the imaging lens.

14. The display light machine of claim 13, wherein the illumination assembly further comprises a plurality of light-homogenizing color-mixing devices, the plurality of light-homogenizing color-mixing devices are stacked in a light path between the illumination light source and the relay assembly.

15. The display light machine of claim 13, wherein an angle distribution range of incident light received by the relay assembly is less than a range of maximum overlapping region of lights with different colors in the mixed-color illumination light.

16. The display light machine of claim 13, wherein an angel distribution range of incident light received by the light-homogenizing color-mixing device is greater than a maximum value of a range of angular distribution of the multi-color illumination light.

17. A near-eye display device, comprising:
a device body; and
the display light machine of claim 13, wherein the display light machine is mounted on the device body.

18. The near-eye display device of claim 17, wherein the illumination assembly further comprises a plurality of light-homogenizing color-mixing devices, the plurality of light-homogenizing color-mixing devices are stacked in a light path between the illumination light source and the relay assembly.

19. The near-eye display device of claim 17, wherein an angle distribution range of incident light received by the relay assembly is less than a range of maximum overlapping region of lights with different colors in the mixed-color illumination light.

20. The near-eye display device of claim 17, wherein an angel distribution range of incident light received by the light-homogenizing color-mixing device is greater than a maximum value of a range of angular distribution of the multi-color illumination light.
